(19) United States
(12) Patent Application Publication
(10) Pub. No.: US 2026/0057908 A1
(43) Pub. Date: Feb. 26, 2026

(54) METHOD OF VIDEO PROCESSING, DEVICE, AND STORAGE MEDIUM

(71) Applicant: Beijing Zitiao Network Technology Co., Ltd., Beijing (CN)

(72) Inventors: Jiacai ZHAO, Beijing (CN); Lushuang CHEN, Beijing (CN)

(21) Appl. No.: 19/302,653

(22) Filed: Aug. 18, 2025

(30) Foreign Application Priority Data
Aug. 21, 2024 (CN) 202411155599.6

(51) Int. Cl. G11B 27/00; G11B 27/34

(52) U.S. Cl. CPC G11B 27/005; G11B 27/34

(57) ABSTRACT

A method of video processing, a device, and a storage medium are provided. The method includes: determining a visual rhythm point according to motion information of a target object in an original video; determining an audio rhythm point according to audio information corresponding to the original video; determining a target visual rhythm point that matches the audio rhythm point according to the timestamp corresponding to the audio rhythm point, and forming a rhythm point pair according to the audio rhythm point and the corresponding target visual rhythm point; and determining a target variable speed curve according to audio rhythm points and target visual rhythm points in adjacent rhythm point pairs, and changing a video speed of the original video according to the target variable speed curve to obtain a target video.

### CROSS-REFERENCE TO RELATED APPLICATION

The present application claims priority of the Chinese Patent Application No. 202411155599.6, filed on Aug. 21, 2024, the disclosure of which is incorporated herein by reference in its entirety as part of the present application.

### TECHNICAL FIELD

Embodiments of the present disclosure relate to a method of video processing, an apparatus of video processing, a device, a medium and a program product.

### BACKGROUND

As computer technologies keep developing, users have increasingly diversified demands for video processing. For example, a user may need to transfer a music video (MV) or a dance video into a variable-speed beat-synced video.

At present, based on fixed-interval beats or a simple rhythmic beat, a same curve is used to repeatedly change the speed of an original video, to obtain a variable-speed beat-synced video. However, this method of obtaining a variable-speed beat-synced video has problems such as mismatch between the movement and the audio or the unstable beat-syncing effect, which affect the audio-visual effect of the variable-speed beat-synced video.

### SUMMARY

The embodiments of the present disclosure provide a method of video processing, an apparatus of video processing, a device, a medium and a program product, which can solve the problems of mismatch between a movement and an audio and an unstable beat-syncing effect, and improve the audio-visual effect of the variable-speed beat-synced video.

In the first aspect, an embodiment of the present provides a method of video processing, which includes: determining a visual rhythm point according to motion information of a target object in an original video, where the visual rhythm point represents a timestamp corresponding to motion information that meets a preset condition; determining an audio rhythm point according to audio information corresponding to the original video, where the audio rhythm point represents a timestamp corresponding to a rhythm varying point in the audio information; determining a target visual rhythm point that matches the audio rhythm point according to the timestamp corresponding to the audio rhythm point, and forming a rhythm point pair according to the audio rhythm point and the corresponding target visual rhythm point; and determining a target variable speed curve according to audio rhythm points and target visual rhythm points in adjacent rhythm point pairs, and changing a video speed of the original video according to the target variable speed curve to obtain a target video.

In the second aspect, an embodiment of the present further provides an apparatus of video processing, which includes a visual rhythm point determining module, an audio rhythm point determining module, a rhythm point matching module and a video speed-changing module. The visual rhythm point determining module is configured to determine a visual rhythm point according to motion information of a target object in an original video, where the visual rhythm point represents a timestamp corresponding to motion information that meets a preset condition. The audio rhythm point determining module is configured to determine an audio rhythm point according to audio information corresponding to the original video, where the audio rhythm point represents a timestamp corresponding to a rhythm varying point in the audio information. The rhythm point matching module is configured to determine a target visual rhythm point that matches the audio rhythm point according to the timestamp corresponding to the audio rhythm point, and form a rhythm point pair according to the audio rhythm point and the corresponding target visual rhythm point. The video speed-changing module is configured to determine a target variable speed curve according to audio rhythm points and target visual rhythm points in adjacent rhythm point pairs, and change a video speed of the original video according to the target variable speed curve to obtain a target video.

In the third aspect, an embodiment of the present further provides an electronic device, which includes one or more processors and a memory. The memory is configured to store one or more programs. When the one or more programs are executed by the one or more processors, the one or more processors are caused to implement the method of video processing according to any embodiment of the present disclosure.

In the fourth aspect, an embodiment of the present further provides a storage medium including a computer-executable instruction, where when the computer-executable instruction is executed by a computer processor, the computer-executable instruction is used to implement the method of video processing according to any embodiment of the present disclosure.

In the fifth aspect, an embodiment of the present further provides a computer program product, which includes a computer program. When the computer program is executed by a processor, the processor is caused to implement the method of video processing according to any embodiment of the present disclosure.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic flow chart of a method of video processing provided in an embodiment of the present disclosure;

FIG. 2 is a schematic diagram of a target variable speed curve provided in an embodiment of the present disclosure;

FIG. 3 is a schematic diagram of interpolating a frame in a video sequence provided in an embodiment of the present disclosure;

FIG. 4 is a schematic flow chart of a method of generating a variable-speed beat-synced video provided in an embodiment of the present disclosure;

FIG. 5 is a schematic structural diagram of an apparatus of video processing provided in an embodiment of the present disclosure; and

FIG. 6 is a schematic structural diagram of an electronic device provided in an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

Modifications of “one” and “more” mentioned in the present disclosure are schematic rather than restrictive, and those skilled in the art should understand that unless otherwise explicitly stated in the context, it should be understood as “one or more”.

The names of messages or information exchanged between a plurality of apparatuses in the implementations of the present disclosure are used for illustrative purposes only, and are not used to limit the scope of these messages or information.

It can be understood that the data involved in the technical solutions (including, but not limited to, the data itself and the access to or use of the data) shall comply with the requirements of corresponding laws, regulations, and relevant provisions.

FIG. 1 is a schematic flow chart of a method of video processing provided in an embodiment of the present disclosure. The embodiments of the present disclosure are applicable to the editing of a video, for example, changing the speed of a music video with a curve to obtain a variable-speed beat-synced video. The method may be implemented by an apparatus of video processing, which may be embodied by software and/or hardware, or optionally, by an electronic device. The electronic device may be a mobile terminal, a PC terminal or a server, or the like.

As shown in FIG. 1, the method includes steps S110 to S140.
S110: determining a visual rhythm point according to motion information of a target object in an original video, where the visual rhythm point represents a timestamp corresponding to motion information that meets a preset condition.

The original video represents a video file or an audio-video file of which the video speed is to be changed. In response to the original video being a video file, an audio file needs to be imported to generate a target video. For example, the target video is a variable-speed beat-synced video. In response to the original video being an audio-video file, a variable-speed beat-synced video may be generated based on the content of video frames and the audio information. Optionally, the original video may be a music video (MV), such as a song's MV or a dance video.

The target object may represent a foreground object in a video image of the original video that meets a preset object selection condition. The foreground object may be a person, an animal, a comic book character, a virtual person or a character generated by a generative model that occupies the main position in a video frame. The preset object selection condition may be a condition for selecting a main character in the video image. Because the main character in a video image is usually the largest foreground object in the video image, the target object may be determined in the foreground objects based on the area for a foreground object.

The motion information represents a movement of the target object. For example, in a dance video, the movement information of the target object represents a dance movement of the main character, or the like. The motion information may be traversed through a sliding window to obtain the motion information that meets the preset condition, and a visual rhythm point may be determined based on the motion information that meets the preset condition. Since the motion information of the target object is information on change of time, a motion information curve may be determined according to a timestamp of a video frame and the motion information of the target object in the video frame. A sliding window of a set size is used to slide along the motion information curve to acquire the motion information that meets the preset condition in each sliding window. A radius of the sliding window may be used to represent the size of the sliding window, and the radius of the sliding window may be set according to an actual application scenario.

As an example, the determining a visual rhythm point according to motion information of a target object in an original video, includes: splitting the original video into at least one video segment according to content information of the original video; determining the target object in a foreground object in the video segment according to an area for the foreground object; determining, for a video frame in the video segment, the motion information of the target object in the video frame according to a pixel difference of the target object in adjacent video frames; and determining a visual rhythm point of the video segment according to the motion information of the target object in the video frame.

Because the original video is a video frame sequence and may correspond to a video image in multiple shots, different shots may have different target objects, and even a target object may cover a different area in the same shot because the target object is in motion, such that the video segment corresponding to the same shot includes a plurality of target objects. To simplify the calculation, the original video may be split into a plurality of video segments. Optionally, the video frames in each video segment represent a video frame in the same shot. Then, for each video segment, the target object is selected from the foreground objects.

The original video may be split in many ways, which are not limited specifically in the embodiments of this disclosure. For example, a transition detection may be performed according to the video image detection of the original video to determine transition information. The original video is split into a plurality of video segments based on the transition information. Alternatively, two video frames that have a large pixel difference are determined according to a pixel difference of any two adjacent video frames in the original video, and the two video frames are split to different video segments.

For example, for video frames in each video segment, the image area for a foreground object in the video frame is determined. In response to the image area of the foreground object meeting the preset object selection condition, the foreground object is determined as the target object in the current video frame, that is, the main character in the current video frame.

Optionally, when a foreground object in the video screen is identified, a bounding box with a set shape is used to mark the foreground object, and to simplify the calculation, the area of the bounding box may be calculated. Then, the area of the bounding box of the foreground object represents the area of the foreground object in the video frame. Furthermore, the foreground object in the bounding box that has the largest area is selected as the target object. Optionally, coordinates of the bounding box corresponding to the target object is cached. In response to the bounding box being rectangular, coordinates of vertices at both ends of a diagonal in the bounding box are cached. For example, the coordinates of the upper left vertex and lower right vertex of the bounding box corresponding to each target object are cached.

Any video frame in any video segment is used as the current video frame, according to the bounding box of the target object in the current video frame, a local image corresponding to the target object in the current video frame is acquired from the video image of the current video frame. The motion information of the target object in the current video frame is determined according to the local image corresponding to the target object in the current video frame and the local image corresponding to the target object in the previous video frame. Specifically, a local image Pi including the target object is cropped from the current video frame according to the bounding box of the target object in the current video frame. The local image Pi−1 corresponding to the target object in the previous video frame is acquired, and an average value of pixel difference between the local image Pi and the local image Pi−1 is calculated as the motion information Mi of the target object in the current frame. It should be noted that the local image corresponding to the target object in the previous video frame is acquired in the same way as the current video frame, which is not described again here. Optionally, the local image Pi may be scaled to the same size as the local image Pi−1 before calculating the pixel difference, so as to facilitate calculation of the pixel difference.

The visual rhythm point of the video segment is determined according to the motion information Mi (i=1, 2, 3, . . . , N) of the target object in the video frames in the video segment. Specifically, for a video frame in the video segment, a preset sliding window is used to traverse the motion information of the target object in the video frame to obtain target motion information that meets the preset selection condition, and the visual rhythm point of the video segment is determined according to the moment corresponding to the target motion information.

The preset selection condition may be used to select the target motion information from the motion information covered by the preset sliding window. For example, the preset selection condition may be selecting a minimum value of the motion information in the selection window, or the like. Because the motion information is determined based on the pixel difference between the target object in the current video frame and the target object in the previous frame, a curve of the motion information in the video segment over time may be drawn. Then, the preset sliding window is used to slide on the curve to acquire the minimum value of the motion information in each sliding window. The moment corresponding to the minimum value of the motion information in the video segment is used as the visual rhythm point of the video segment. For example, the visual rhythm point sequence vbeats[v_pts1, v_pts2, v_pts3, v_pts4, . . . ] may be used to represent the visual rhythm points of the original video, where v_pts1, v_pts2, v_pts3, v_pts4, . . . represent the visual rhythm points sorted by timestamp.
S120: determining an audio rhythm point according to audio information corresponding to the original video, where the audio rhythm point represents a timestamp corresponding to a rhythm varying point in the audio information.

In the embodiments of the present disclosure, the audio information may be an audio in the original video, or an audio file uploaded by a user. The rhythm varying point in the audio information may be detected by audio feature analysis or a rhythm point detection algorithm, or the like, and the audio rhythm point may be determined according to the rhythm varying point. For example, the audio rhythm point sequence abeats[a_pts1, a_pts2, a_pts3, a_pts4, . . . ] may be used to represent the audio rhythm points in the audio information, where a_pts1, a_pts2, a_pts3, a_pts4, . . . represent the audio rhythm points sorted by timestamp.

For example, at least one rhythm varying point may be determined as an audio rhythm point based on an energy waveform of the audio information in a frequency domain. And/or, a rhythm varying point in the audio information may be determined as the audio rhythm point according to a beat recognition algorithm. And/or, a rhythm recognition model is trained based on existing audio files that have a good audio rhythm, and the rhythm recognition model is used to automatically determine the audio rhythm point in the audio information.
S130: determining a target visual rhythm point that matches the audio rhythm point according to the timestamp corresponding to the audio rhythm point, and forming a rhythm point pair according to the audio rhythm point and the corresponding target visual rhythm point.

In the embodiments of the present disclosure, matching the visual rhythm point with the audio rhythm point is intended to align the audio rhythm point and the visual rhythm point on the time axis, so as to solve the problem that the video and audio are not synchronous.

As an example, a candidate offset of the visual rhythm point is acquired, where the candidate offset is an offset of a timestamp. A matching error between the audio rhythm point and the visual rhythm point is determined according to the timestamp corresponding to the audio rhythm point, the timestamp corresponding to the visual rhythm point and the candidate offset. The candidate offset that has a matching error meeting a preset matching condition is used as a target offset, and the offset processing is performed on the visual rhythm point based on the target offset. The visual rhythm point after being offset is searched for according to the timestamp corresponding to the audio rhythm point, and the target visual rhythm point that matches the audio rhythm point is determined.

The candidate offset may be preset based on an empirical offset value between the visual rhythm point and the audio rhythm point. The matching error may be determined based on the timestamps of each audio rhythm point in the audio rhythm point sequence and the corresponding visual rhythm point. For example, the matching error may be a sum of average values of timestamp distances between audio rhythm points and the corresponding visual rhythm points. The preset matching condition is used to select the target offset from the candidate offsets based on the matching error. For example, the preset matching condition may be using a candidate offset with the smallest match error as the target offset, or the like. The offset processing is performed on the visual rhythm point based on the target offset, so that the visual rhythm point is roughly aligned with the audio rhythm point on the time axis. The target visual rhythm point represents the visual rhythm point closest to the audio rhythm point on the time axis.

Specifically, the searching for a visual rhythm point after being offset according to the timestamp corresponding to the audio rhythm point, and determining the target visual rhythm point that matches the audio rhythm point, includes: determining a search time interval according to the timestamp corresponding to the audio rhythm point, and searching for the visual rhythm point after being offset in the search time interval; in response to the search time interval including the visual rhythm point, determining the target visual rhythm point according to the visual rhythm point in the search time interval; and in response to the search time interval not including the visual rhythm point, determining the target visual rhythm point according to the audio rhythm point.

The search time interval represents a timestamp range of the audio rhythm point in which the visual rhythm point is searched for on the time axis. For example, the search time interval may represent a timestamp range obtained by expanding a set time range to the left and right from each audio rhythm point.

In the embodiments of the present disclosure, after performing offset processing on the visual rhythm point, the audio rhythm point in the audio rhythm point sequence is used as a reference point to search for the target visual rhythm point that matches the reference point from the visual rhythm point after being offset. The target visual rhythm point is the visual rhythm point closest to the timestamp of the reference point. Alternatively, a difference between the audio rhythm point at the current moment and the audio rhythm point at the previous moment is determined as a first difference, a difference between the target visual rhythm point at the current moment and the target visual rhythm point at the previous moment is determined as a second difference, and the target visual rhythm point at the current moment makes the difference between the first difference and the second difference smaller than a set threshold. The preset threshold may be set based on an actual application scenario. Alternatively, in response to no visual rhythm point close to the reference point, the target visual rhythm point may be determined based on the timestamp corresponding to the reference point.

In the embodiments of the present disclosure, after determining the target visual rhythm point that matches the audio rhythm point, a rhythm point pair is formed based on the audio rhythm point and the corresponding target visual rhythm point, and may be expressed as {Vᵢ, Aᵢ}, i=1, . . . , N.
S140: determining a target variable speed curve according to audio rhythm points and target visual rhythm points in adjacent rhythm point pairs, and changing a video speed of the original video according to the target variable speed curve to obtain a target video.

In the embodiments of the present disclosure, the determining a target variable speed curve, and changing a video speed of the original video according to the target variable speed curve to obtain a target video, includes: determining a variable speed curve between the adjacent rhythm point pairs according to the audio rhythm points and the target visual rhythm points in the adjacent rhythm point pairs, where the variable speed curve represents a curve of a video playback speed varying over time; and determining the target variable speed curve of the original video according to the variable speed curve between the adjacent rhythm point pairs, and changing the video speed of the original video according to the target variable speed curve to obtain the target video.

As an example, an abscissa of a target coordinate point is determined according to the audio rhythm points in the adjacent rhythm point pairs. A reference speed is determined according to the audio rhythm points and the target visual rhythm points in the adjacent rhythm point pairs, and an ordinate of the target coordinate point is determined according to the reference speed. The variable speed curve between the adjacent rhythm point pairs is drawn according to the target coordinate point.

The abscissa of the target coordinate point is a timestamp interpolated between the adjacent rhythm point pairs, and the ordinate is the video playback speed. For example, to draw the variable speed curve between the adjacent rhythm point pairs, four target coordinate points are interpolated between the adjacent rhythm point pairs. An interpolation algorithm may be used to determine the timestamp interpolated based on the audio rhythm points in the adjacent rhythm point pairs. The reference speed represents the speed-changing basis for the video playback speed between the adjacent rhythm point pairs. The reference speed may be multiplied by a set factor to obtain the video playback speed at the audio rhythm points in the adjacent rhythm point pairs and the interpolated point. Based on the target coordinate point, the interpolation method is used to determine the variable speed curve.

Because the original video includes a plurality of video segments, the visual rhythm point and the audio rhythm point are determined for each video segment, and after the visual rhythm point is aligned with the audio rhythm point on the time axis, a rhythm point pair consisting of the audio rhythm point and the visual rhythm point is obtained. Therefore, the original video includes a plurality of rhythm point pairs. For adjacent rhythm pairs, the variable speed curve between the adjacent rhythm pairs is determined by the above manner. The variable speed curves between the adjacent rhythm pairs are combined according to the timestamp order to obtain the target variable speed curve corresponding to the original video.

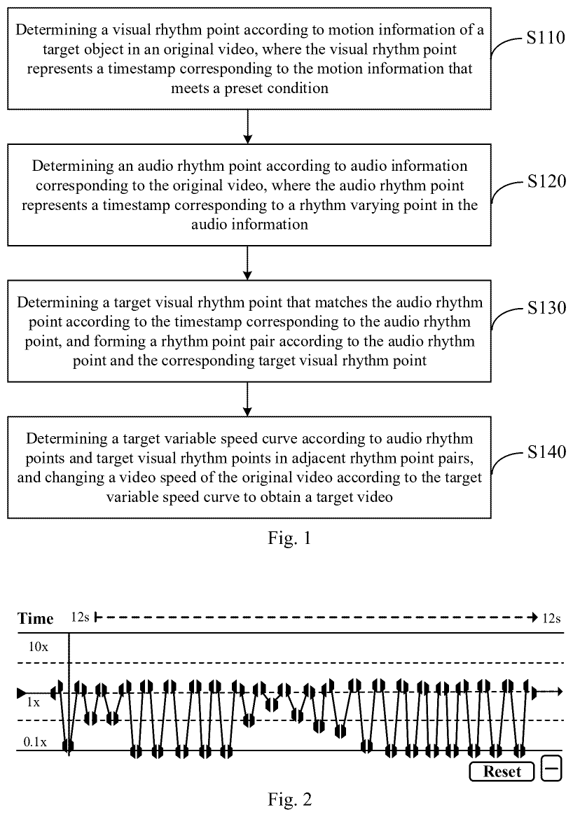

FIG. 2 is a schematic diagram of a target variable speed curve provided in an embodiment of the present disclosure. As shown in FIG. 2, the variable speed curve between the adjacent rhythm point pairs shows a tendency that the video playback speed decreases first and then increases. Different variable speed curves have different speed-varying amplitudes, indicating that the video playback speed does not change uniformly, but is adaptively adjusted according to the audio rhythm points.

Optionally, the determining the target variable speed curve of the original video according to the variable speed curve between the adjacent rhythm point pairs, and changing the video speed of the original video according to the target variable speed curve to obtain the target video, includes: combining the variable speed curve between the adjacent rhythm pairs according to a timestamp order to obtain the target variable speed curve of the original video; and changing, based on the target variable speed curve, the video speed of the original video by using a manner of interpolating frames to obtain the target video.

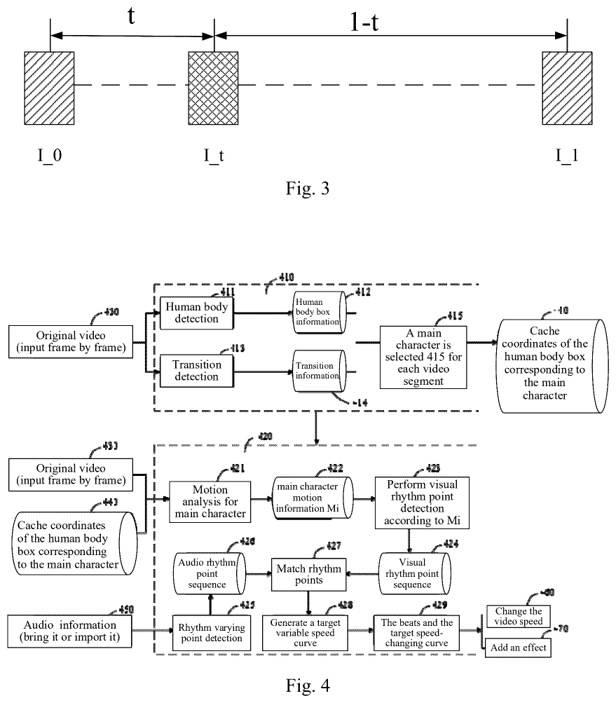

The frame interpolation includes optical flow frame interpolation. The optical flow interpolation includes: calculating a motion trajectory of pixels in adjacent video frames (denoted as I_0 and I_1) to generate a video frame (I_t) at an intermediate moment t. FIG. 3 is a schematic diagram of interpolating a frame in a video sequence provided in an embodiment of the present disclosure. As shown in FIG. 3, a video frame I_t is interpolated at the moment t between the adjacent video frames I_0 and I_1.

Optionally, a target effect material may be added to the video image corresponding to the set audio rhythm point based on the variable speed curve, so as to implement the effect in the original video.

The technical solution provided in the embodiments of the present disclosure determines the visual rhythm point and the audio rhythm point of the original video and determines the target visual rhythm point that matches the audio rhythm point according to the timestamp corresponding to the audio rhythm point to align the visual rhythm point to the audio rhythm point on the time axis, and then forms a rhythm point pair according to the audio rhythm point and the corresponding visual rhythm point. A target variable speed curve is determined according to the audio rhythm point and the target visual rhythm point in adjacent rhythm point pairs and the video speed of the original video is changed according to the target variable speed curve to obtain a target video. The embodiments of the present disclosure change the speed of the original video through the target variable speed curve to align the motion of the target object in the target video with the rhythm of the audio information, and make the rhythm adaptively varying with the movement, thereby improving the stability of the beat-syncing effect, solving the problems of mismatch between the movement and the audio and the unstable beat-syncing effect, and improving the audio-visual effect of the variable-speed beat-synced video.

FIG. 4 is a schematic flow chart of a method of generating a variable-speed beat-synced video provided in an embodiment of the present disclosure. FIG. 4 specifically illustrates a process of generating the variable-speed beat-synced video. As shown in FIG. 4, the process of generating the variable-speed beat-synced video includes an information preprocessing stage 410 and a variable speed curve generation stage 420. In the information preprocessing stage 410, human body box information 412 is obtained by performing the human body detection 411 on a video frame corresponding to the original video 430. Transition information 414 is obtained by performing the transition detection 413 on the video frame corresponding to the original video 430. Based on the transition information 414, the original video is split into independent video segments.

A main character is selected 415 for each video segment. Specifically, the main character suitable for motion analysis is selected from a plurality of human bodies in each video segment. Generally, the human body with a human body box that covers the largest area is used as the main character. Coordinates 440 of the human body box corresponding to the main character are cached. In the variable speed curve generation stage 420, the motion analysis 421 for the main character is performed by combining the video frame corresponding to the original video 430 and the coordinates 440 of the human body box corresponding to the video frame. Specifically, the video frame of the original video 430 is traversed as the current video frame, and a local image Pi of the main character in the current video frame is cropped based on the coordinates 440 of the human body box corresponding to the current video frame. Based on the coordinates 440 of the human body box corresponding to the previous frame of the current video frame, the local image Pi−1 of the main character in the previous video frame is cropped. The local images Pi and Pi−1 are scaled to the same size, and then the average value of the pixel differences between the two local images is calculated as the main character motion information 422 of the current video frame. The main character motion information 422 of each video frame in the original video 430 is determined in a similar way, which is denoted as Mi, where i=1, 2, 3, . . . , N.

A visual rhythm point detection 423 is performed according to Mi. Specifically, the minimum main character motion information is determined by using a set sliding window to traverse the main character motion information corresponding to the video frame in the original video 430. The timestamp corresponding to the minimum main character motion information is used as the visual rhythm point. A visual rhythm point sequence 424 is cached, denoted as vbeats[v_pts1, v_pts2, v_pts3, v_pts4, . . . ]. The audio information 450 is performed the rhythm varying point detection 425 to obtain an audio rhythm point sequence 426, denoted as abeats[a_pts1, a_pts2, a_pts3, a_pts4, . . . ].

The rhythm points are matched 427 based on the audio rhythm point sequence 426 and the visual rhythm point sequence 424. Specifically, the visual rhythm points in the visual rhythm point sequence 424 are matched with the audio rhythm points in the audio rhythm point sequence 426, to align the main character motions with the audio on the time axis, which includes both global matching and local fine matching.

Considering that the original video and the audio are asynchronous, a candidate offset is searched for to obtain a target offset before matching the rhythm points. The visual rhythm points are offset as a whole based on the target offset, so that the visual rhythm points are roughly aligned with the audio rhythm points on the time axis. The above search may be implemented by using a time difference value of the nearest adjacent rhythm points. The candidate offsets may be enumerated to calculate a matching error between each audio rhythm point in the audio rhythm point sequence 426 and the corresponding visual rhythm point in the visual rhythm point sequence 424 in each candidate offset. The matching error is the sum of the squares of the timestamp distances. For any audio rhythm point a_pts_i in the audio rhythm point sequence 426, the timestamp distance between the corresponding visual rhythm points v_pts_i and a_pts_i is smaller than the set threshold, that is, the visual rhythm point corresponding to the audio rhythm point is the point near the timestamp corresponding to the audio rhythm point. In response to no visual rhythm point being present near the timestamp corresponding to the audio rhythm point, the audio rhythm point is excluded from calculation of the matching error. The candidate offset with the smallest matching error is used as the target offset to adjust the visual rhythm point based on the target offset, so that the visual rhythm point is roughly aligned with the audio rhythm point on the time axis.

Then, the rhythm points in the visual rhythm point sequence 424 after being offset and the rhythm points in the audio rhythm point sequence 426 are matched one by one. For any audio rhythm point a_pts_i in the audio rhythm point sequence 426, the corresponding target visual rhythm point v_pts_i is searched for in the visual rhythm point sequence 424 after being offset. The target visual rhythm point v_pts_i meets the following condition: the target visual rhythm point is the visual rhythm point closest to a_pts_i within the search range with a radius of the set timestamp by using a_pts_i as the reference point. When there is no visual rhythm point within the search range, the current point a_pts_i is used to directly replace the visual rhythm point, that is, the timestamp corresponding to the current audio rhythm point is interpolated on the time axis corresponding to the visual rhythm point and is used as the target visual rhythm point corresponding to the current point a_pts_i. Optionally, the target visual rhythm point may also meet the following condition: a difference of the audio rhythm points between a moment i and a moment i−1 and a difference of the visual rhythm points between the moment i and the moment i−1 have a difference smaller than the set threshold. According to the above method, the target visual rhythm point aligned with the audio rhythm point is determined, and the rhythm point pair is obtained by combining each audio rhythm point and the corresponding target visual rhythm point, denoted as {Vᵢ, Aᵢ}, i=1, . . . , N.

In combination to the rhythm point pair, the target variable speed curve 428 is generated to output the beats and the target speed-changing curve 429. The coordinate points of the target variable speed curve 429 may be expressed as (timestamp, video playback speed). Specifically, a variable speed curve between adjacent rhythm point pairs is generated segment by segment based on the rhythm point pair {Vᵢ, Aᵢ}. A ratio of the difference between the visual rhythm points Vᵢ and Vᵢ₋₁ in adjacent rhythm point pairs to the difference between the audio rhythm points Aᵢ and Aᵢ₋₁ in the adjacent rhythm point pairs may be calculated as a reference speed. To facilitate calculation, four target coordinate points are interpolated between two adjacent rhythm point pairs. The video playback speed at the audio rhythm point Aᵢ₋₁ is the result

$${y}_{i}^{1}$$

obtained by multiplying the reference speed by a first factor, and correspondingly, the first target coordinate point maybe expressed as

$$( {A}_{i - 1} , {y}_{i}^{1} ) .$$

The abscissa of the interpolated points may be determined based on the adjacent audio rhythm points corresponding to the adjacent rhythm points. For example, the abscissa of the interpolated points is the average value of the audio rhythm points Aᵢ and Aᵢ₋₁. The ordinate of the interpolated points is the result

$${y}_{i}^{2} and {y}_{i}^{3}$$

obtained by multiplying the reference speed by a second factor.

$${y}_{i}^{2}$$

may be equal to

$${y}_{i}^{3} .$$

Correspondingly, the second target coordinate point may be expressed as

$$( \frac{{A}_{i - 1} + {A}_{i}}{2} , {y}_{i}^{2} ) ,$$

and the third target coordinate point maybe expressed as

$$( \frac{{A}_{i - 1} + {A}_{i}}{2} , {y}_{i}^{3} ) .$$

The video playback speed at the audio rhythm point Aᵢ is the result

$${y}_{i}^{4}$$

obtained by multiplying the reference speed by the first factor, and correspondingly, the fourth target coordinate point maybe expressed as

$$( {A}_{i} , {y}_{i}^{4} ) .$$

The first factor is greater than the second factor. Based on the fourth coordinate point, the interpolation method is used to determine the variable speed curve. According to the corresponding variable speed curve of adjacent rhythm point pairs, the target variable speed curve 429 corresponding to the original video is determined. Changing the video speed 460 or adding an effect 470 is performed according to the visual rhythm point sequence 424, the audio rhythm point sequence 426, and the target variable speed curve 429. In order to change video speed by a non-integer multiple, the optical flow interpolation method is used to interpolate a video frame into the original video through a video speed-changing module based on the target variable speed curve to obtain the target video.

The embodiments of the present disclosure perceive information such as scenes, motions, and music beats in the audio information in the original video to align the visual rhythm point and the audio rhythm point, thereby generating a variable speed curve with rhythmic changes, and generating a target variable speed curve based on the variable speed curve, and then changing a video speed of the video based on the target variable speed curve, and outputting a natural, stable and visually contrasting variable-speed beat-synced video that has a better audio-visual effect.

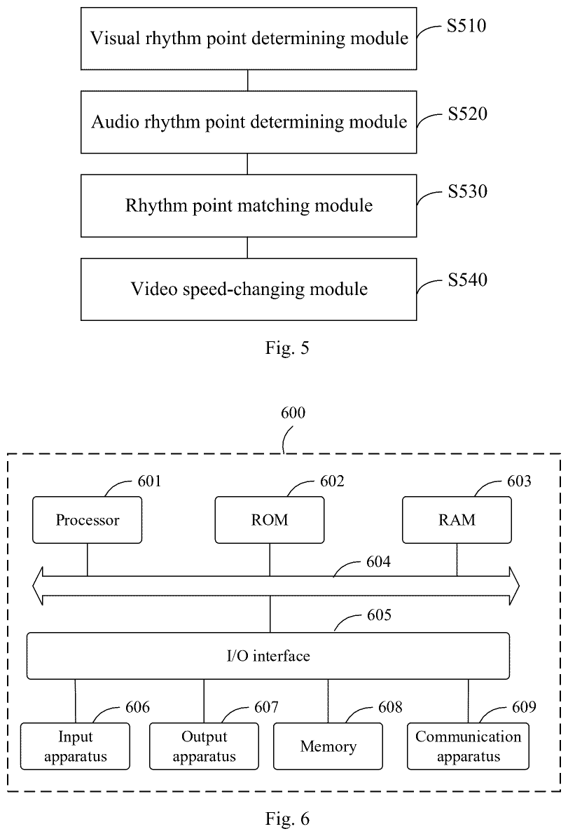

FIG. 5 is a schematic structural diagram of an apparatus of video processing provided in an embodiment of the present disclosure. The apparatus may be embodied by software and/or hardware, or optionally, by an electronic device, which may be a mobile terminal, a PC terminal or a server, or the like.

As shown in FIG. 5, the apparatus includes a visual rhythm point determining module 510, an audio rhythm point determining module 520, a rhythm point matching module 530 and a video speed-changing module 540.

The visual rhythm point determining module 510 is configured to determine a visual rhythm point according to motion information of a target object in an original video, where the visual rhythm point represents a timestamp corresponding to motion information that meets a preset condition.

The audio rhythm point determining module 520 is configured to determine an audio rhythm point according to audio information corresponding to the original video, where the audio rhythm point represents a timestamp corresponding to a rhythm varying point in the audio information.

The rhythm point matching module 530 is configured to determine a target visual rhythm point that matches the audio rhythm point according to the timestamp corresponding to the audio rhythm point, and form a rhythm point pair according to the audio rhythm point and the corresponding target visual rhythm point.

The video speed-changing module 540 is configured to determine a target variable speed curve according to audio rhythm points and target visual rhythm points in adjacent rhythm point pairs, and change a video speed of the original video according to the target variable speed curve to obtain a target video.

Optionally, the visual rhythm point determining module 510 is specifically configured to: split the original video into at least one video segment according to content information of the original video; determine the target object in a foreground object in the video segment according to an area for the foreground object; determine, for a video frame in the video segment, the motion information of the target object in the video frame according to a pixel difference of the target object in adjacent video frames; and determine a visual rhythm point of the video segment according to the motion information of the target object in the video frame.

Furthermore, the determining a visual rhythm point of the video segment according to the motion information of the target object in the video frame, includes: traversing, for the video frame in the video segment, the motion information of the target object in the video frame by using a preset sliding window to obtain target motion information that meets a preset selection condition; and determining the visual rhythm point of the video segment according to a moment corresponding to the target motion information.

Optionally, the rhythm point matching module 530 is specifically configured to: acquire a candidate offset of the visual rhythm point, where the candidate offset is an offset of a timestamp; determine a matching error between the audio rhythm point and the visual rhythm point according to the timestamp corresponding to the audio rhythm point, a timestamp corresponding to the visual rhythm point, and the candidate offset; determine a candidate offset that has a matching error meeting a preset matching condition as a target offset, and perform offset processing on the visual rhythm point based on the target offset; and search for a visual rhythm point after being offset according to the timestamp corresponding to the audio rhythm point, and determine the target visual rhythm point that matches the audio rhythm point.

Furthermore, the searching for a visual rhythm point after being offset according to the timestamp corresponding to the audio rhythm point, and determining the target visual rhythm point that matches the audio rhythm point, includes: determining a search time interval according to the timestamp corresponding to the audio rhythm point, and searching for the visual rhythm point after being offset in the search time interval; in response to the search time interval including the visual rhythm point, determining the target visual rhythm point according to the visual rhythm point in the search time interval; and in response to the search time interval not including the visual rhythm point, determining the target visual rhythm point according to the audio rhythm point.

Optionally, the video speed-changing module 540 includes a curve generating sub-module and a video speed-changing sub-module. The curve generating sub-module is configured to determine a variable speed curve between the adjacent rhythm point pairs according to the audio rhythm points and the target visual rhythm points in the adjacent rhythm point pairs, where the variable speed curve represents a curve of a video playback speed varying over time. The video speed-changing sub-module is configured to determine the target variable speed curve of the original video according to the variable speed curve between the adjacent rhythm point pairs, and change the video speed of the original video according to the target variable speed curve to obtain the target video.

Optionally, the curve generating sub-module is specifically configured to determine an abscissa of a target coordinate point according to the audio rhythm points in the adjacent rhythm point pairs; determine a reference speed according to the audio rhythm points and the target visual rhythm points in the adjacent rhythm point pairs, and determine an ordinate of the target coordinate point according to the reference speed; and draw the variable speed curve between the adjacent rhythm point pairs according to the target coordinate point.

Optionally, the video speed-changing sub-module is specifically configured to combine the variable speed curve between the adjacent rhythm pairs according to a timestamp order to obtain the target variable speed curve of the original video; and change, based on the target variable speed curve, the video speed of the original video by using a manner of interpolating frames to obtain the target video.

The apparatus of video processing provided by the embodiments of the present disclosure can execute the method of video processing provided by any embodiment of the present disclosure, and has the corresponding functional modules and beneficial effects of the execution method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the protection scope of the embodiments of the present disclosure.

FIG. 6 is a structural schematic diagram of an electronic device according to an embodiment of the present disclosure. Reference is made to FIG. 6 below, which is a structural schematic diagram of an electronic device (such as a terminal device or a server in FIG. 6) 600 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processor (e.g., a central processing unit or a graphics processing unit) 601 that may perform a variety of appropriate actions and processing in accordance with a program stored in a read-only memory (ROM) 602 or a program loaded from a memory 508 into a random access memory (RAM) 603. The RAM 603 further stores various programs and data required for operations of the electronic device 600. The processor 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the memory 608 including, for example, a tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 609 and installed, installed from the memory 608, or installed from the ROM 602. When the computer program is executed by the processor 601, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the method of video processing provided in the above embodiments belong to the same inventive concept. For the technical details not described in detail in this embodiment, reference may made to the above embodiments, and this embodiment and the above embodiments have the same beneficial effects.

An embodiment of the present disclosure provides a computer storage medium storing a computer program thereon. When the program is executed by a processor, the processor implements the method of video processing according to the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determine a visual rhythm point according to motion information of a target object in an original video, where the visual rhythm point represents a timestamp corresponding to motion information that meets a preset condition; determine an audio rhythm point according to audio information corresponding to the original video, where the audio rhythm point represents a timestamp corresponding to a rhythm varying point in the audio information;
determine a target visual rhythm point that matches the audio rhythm point according to the timestamp corresponding to the audio rhythm point, and form a rhythm point pair according to the audio rhythm point and the corresponding target visual rhythm point; and determine a target variable speed curve according to audio rhythm points and target visual rhythm points in adjacent rhythm point pairs, and change a video speed of the original video according to the target variable speed curve to obtain a target video.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A method of video processing, comprising:
determining a visual rhythm point according to motion information of a target object in an original video, wherein the visual rhythm point represents a timestamp corresponding to motion information that meets a preset condition;
determining an audio rhythm point according to audio information corresponding to the original video, wherein the audio rhythm point represents a timestamp corresponding to a rhythm varying point in the audio information;
determining a target visual rhythm point that matches the audio rhythm point according to the timestamp corresponding to the audio rhythm point, and forming a rhythm point pair according to the audio rhythm point and the corresponding target visual rhythm point; and
determining a target variable speed curve according to audio rhythm points and target visual rhythm points in adjacent rhythm point pairs, and changing a video speed of the original video according to the target variable speed curve to obtain a target video.

2. The method according to claim 1, wherein the determining a visual rhythm point according to motion information of a target object in an original video, comprises:
splitting the original video into at least one video segment according to content information of the original video;
determining the target object in a foreground object in the video segment according to an area for the foreground object;
determining, for a video frame in the video segment, the motion information of the target object in the video frame according to a pixel difference of the target object in adjacent video frames; and
determining a visual rhythm point of the video segment according to the motion information of the target object in the video frame.

3. The method according to claim 2, wherein the determining a visual rhythm point of the video segment according to the motion information of the target object in the video frame, comprises:
traversing, for the video frame in the video segment, the motion information of the target object in the video frame by using a preset sliding window to obtain target motion information that meets a preset selection condition; and
determining the visual rhythm point of the video segment according to a moment corresponding to the target motion information.

4. The method according to claim 1, wherein the determining a target visual rhythm point that matches the audio rhythm point according to the timestamp corresponding to the audio rhythm point, comprises:
acquiring a candidate offset of the visual rhythm point, wherein the candidate offset is an offset of a timestamp;
determining a matching error between the audio rhythm point and the visual rhythm point according to the timestamp corresponding to the audio rhythm point, a timestamp corresponding to the visual rhythm point, and the candidate offset;
determining a candidate offset that has a matching error meeting a preset matching condition as a target offset, and performing offset processing on the visual rhythm point based on the target offset; and
searching for a visual rhythm point after being offset according to the timestamp corresponding to the audio rhythm point, and determining the target visual rhythm point that matches the audio rhythm point.

5. The method according to claim 4, wherein the searching for a visual rhythm point after being offset according to the timestamp corresponding to the audio rhythm point, and determining the target visual rhythm point that matches the audio rhythm point, comprises:
determining a search time interval according to the timestamp corresponding to the audio rhythm point, and searching for the visual rhythm point after being offset in the search time interval;
in response to the search time interval comprising the visual rhythm point, determining the target visual rhythm point according to the visual rhythm point in the search time interval; and
in response to the search time interval not comprising the visual rhythm point, determining the target visual rhythm point according to the audio rhythm point.

6. The method according to claim 1, wherein the determining a target variable speed curve according to audio rhythm points and target visual rhythm points in adjacent rhythm point pairs, and changing a video speed of the original video according to the target variable speed curve to obtain a target video, comprises:
determining a variable speed curve between the adjacent rhythm point pairs according to the audio rhythm points and the target visual rhythm points in the adjacent rhythm point pairs, wherein the variable speed curve represents a curve of a video playback speed varying over time; and
determining the target variable speed curve of the original video according to the variable speed curve between the adjacent rhythm point pairs, and changing the video speed of the original video according to the target variable speed curve to obtain the target video.

7. The method according to claim 6, wherein the determining a variable speed curve between the adjacent rhythm point pairs according to the audio rhythm points and the target visual rhythm points in the adjacent rhythm point pairs, comprises:
determining an abscissa of a target coordinate point according to the audio rhythm points in the adjacent rhythm point pairs;
determining a reference speed according to the audio rhythm points and the target visual rhythm points in the adjacent rhythm point pairs, and determining an ordinate of the target coordinate point according to the reference speed; and
drawing the variable speed curve between the adjacent rhythm point pairs according to the target coordinate point.

8. The method according to claim 6, wherein the determining the target variable speed curve of the original video according to the variable speed curve between the adjacent rhythm point pairs, and changing the video speed of the original video according to the target variable speed curve to obtain the target video, comprises:
combining the variable speed curve between the adjacent rhythm pairs according to a timestamp order to obtain the target variable speed curve of the original video; and
changing, based on the target variable speed curve, the video speed of the original video by using a manner of interpolating frames to obtain the target video.

9. An electronic device, comprising:
one or more processors; and
a memory, configured to store one or more programs,
wherein when the one or more programs are executed by the one or more processors, the one or more processors are caused to implement a method of video processing, and the method comprises:
determining a visual rhythm point according to motion information of a target object in an original video, wherein the visual rhythm point represents a timestamp corresponding to motion information that meets a preset condition;
determining an audio rhythm point according to audio information corresponding to the original video, wherein the audio rhythm point represents a timestamp corresponding to a rhythm varying point in the audio information;
determining a target visual rhythm point that matches the audio rhythm point according to the timestamp corresponding to the audio rhythm point, and forming a rhythm point pair according to the audio rhythm point and the corresponding target visual rhythm point; and
determining a target variable speed curve according to audio rhythm points and target visual rhythm points in adjacent rhythm point pairs, and changing a video speed of the original video according to the target variable speed curve to obtain a target video.

10. The electronic device according to claim 9, wherein the determining a visual rhythm point according to motion information of a target object in an original video, comprises:
splitting the original video into at least one video segment according to content information of the original video;
determining the target object in a foreground object in the video segment according to an area for the foreground object;
determining, for a video frame in the video segment, the motion information of the target object in the video frame according to a pixel difference of the target object in adjacent video frames; and
determining a visual rhythm point of the video segment according to the motion information of the target object in the video frame.

11. The electronic device according to claim 10, wherein the determining a visual rhythm point of the video segment according to the motion information of the target object in the video frame, comprises:
traversing, for the video frame in the video segment, the motion information of the target object in the video frame by using a preset sliding window to obtain target motion information that meets a preset selection condition; and
determining the visual rhythm point of the video segment according to a moment corresponding to the target motion information.

12. The electronic device according to claim 9, wherein the determining a target visual rhythm point that matches the audio rhythm point according to the timestamp corresponding to the audio rhythm point, comprises:
acquiring a candidate offset of the visual rhythm point, wherein the candidate offset is an offset of a timestamp;
determining a matching error between the audio rhythm point and the visual rhythm point according to the timestamp corresponding to the audio rhythm point, a timestamp corresponding to the visual rhythm point, and the candidate offset;
determining a candidate offset that has a matching error meeting a preset matching condition as a target offset, and performing offset processing on the visual rhythm point based on the target offset; and
searching for a visual rhythm point after being offset according to the timestamp corresponding to the audio rhythm point, and determining the target visual rhythm point that matches the audio rhythm point.

13. The electronic device according to claim 12, wherein the searching for a visual rhythm point after being offset according to the timestamp corresponding to the audio rhythm point, and determining the target visual rhythm point that matches the audio rhythm point, comprises:
determining a search time interval according to the timestamp corresponding to the audio rhythm point, and searching for the visual rhythm point after being offset in the search time interval;
in response to the search time interval comprising the visual rhythm point, determining the target visual rhythm point according to the visual rhythm point in the search time interval; and
in response to the search time interval not comprising the visual rhythm point, determining the target visual rhythm point according to the audio rhythm point.

14. The electronic device according to claim 9, wherein the determining a target variable speed curve according to audio rhythm points and target visual rhythm points in adjacent rhythm point pairs, and changing a video speed of the original video according to the target variable speed curve to obtain a target video, comprises:
determining a variable speed curve between the adjacent rhythm point pairs according to the audio rhythm points and the target visual rhythm points in the adjacent rhythm point pairs, wherein the variable speed curve represents a curve of a video playback speed varying over time; and
determining the target variable speed curve of the original video according to the variable speed curve between the adjacent rhythm point pairs, and changing the video speed of the original video according to the target variable speed curve to obtain the target video.

15. A non-transitory computer-readable storage medium comprising a computer-executable instruction, wherein when the computer-executable instruction is executed by a computer processor, the computer-executable instruction is used to implement a method of video processing, and the method comprises:
determining a visual rhythm point according to motion information of a target object in an original video, wherein the visual rhythm point represents a timestamp corresponding to motion information that meets a preset condition;
determining an audio rhythm point according to audio information corresponding to the original video, wherein the audio rhythm point represents a timestamp corresponding to a rhythm varying point in the audio information;
determining a target visual rhythm point that matches the audio rhythm point according to the timestamp corresponding to the audio rhythm point, and forming a rhythm point pair according to the audio rhythm point and the corresponding target visual rhythm point; and
determining a target variable speed curve according to audio rhythm points and target visual rhythm points in adjacent rhythm point pairs, and changing a video speed of the original video according to the target variable speed curve to obtain a target video.

16. The non-transitory computer-readable storage medium according to claim 15, wherein the determining a visual rhythm point according to motion information of a target object in an original video, comprises:
splitting the original video into at least one video segment according to content information of the original video;
determining the target object in a foreground object in the video segment according to an area for the foreground object;
determining, for a video frame in the video segment, the motion information of the target object in the video frame according to a pixel difference of the target object in adjacent video frames; and
determining a visual rhythm point of the video segment according to the motion information of the target object in the video frame.

17. The non-transitory computer-readable storage medium according to claim 16, wherein the determining a visual rhythm point of the video segment according to the motion information of the target object in the video frame, comprises:
traversing, for the video frame in the video segment, the motion information of the target object in the video frame by using a preset sliding window to obtain target motion information that meets a preset selection condition; and
determining the visual rhythm point of the video segment according to a moment corresponding to the target motion information.

18. The non-transitory computer-readable storage medium according to claim 15, wherein the determining a target visual rhythm point that matches the audio rhythm point according to the timestamp corresponding to the audio rhythm point, comprises:
acquiring a candidate offset of the visual rhythm point, wherein the candidate offset is an offset of a timestamp;
determining a matching error between the audio rhythm point and the visual rhythm point according to the timestamp corresponding to the audio rhythm point, a timestamp corresponding to the visual rhythm point, and the candidate offset;
determining a candidate offset that has a matching error meeting a preset matching condition as a target offset, and performing offset processing on the visual rhythm point based on the target offset; and
searching for a visual rhythm point after being offset according to the timestamp corresponding to the audio rhythm point, and determining the target visual rhythm point that matches the audio rhythm point.

19. The non-transitory computer-readable storage medium according to claim 18, wherein the searching for a visual rhythm point after being offset according to the timestamp corresponding to the audio rhythm point, and determining the target visual rhythm point that matches the audio rhythm point, comprises:
determining a search time interval according to the timestamp corresponding to the audio rhythm point, and searching for the visual rhythm point after being offset in the search time interval;
in response to the search time interval comprising the visual rhythm point, determining the target visual rhythm point according to the visual rhythm point in the search time interval; and
in response to the search time interval not comprising the visual rhythm point, determining the target visual rhythm point according to the audio rhythm point.

20. The non-transitory computer-readable storage medium according to claim 15, wherein the determining a target variable speed curve according to audio rhythm points and target visual rhythm points in adjacent rhythm point pairs, and changing a video speed of the original video according to the target variable speed curve to obtain a target video, comprises:
determining a variable speed curve between the adjacent rhythm point pairs according to the audio rhythm points and the target visual rhythm points in the adjacent rhythm point pairs, wherein the variable speed curve represents a curve of a video playback speed varying over time; and
determining the target variable speed curve of the original video according to the variable speed curve between the adjacent rhythm point pairs, and changing the video speed of the original video according to the target variable speed curve to obtain the target video.
